(19) United States
(12) Patent Application Publication
(10) Pub. No.: US 2026/0241629 A1
(43) Pub. Date: Aug. 20, 2026

(54) HEATER FOR A PREFORM USED IN CONTAINER MANUFACTURING

(71) Applicant: Discma AG, Hünenberg (CH)

(72) Inventors: Dave York, Zeeland, MI (US); Dean Hilton, Muskegon, MI (US)

(21) Appl. No.: 18/879,021

(22) PCT Filed: Jun. 30, 2023
(86) PCT No.: PCT/IB2023/056865

§ 371 Date: Dec. 26, 2024

Related U.S. Application Data
(60) Provisional application No. 63/367,380, filed on Jun. 30, 2022.

(51) Int. Cl. B29C 49/64; B29C 49/68

(52) U.S. Cl. CPC B29C 49/6418; B29C 49/68

(57) ABSTRACT

A method and system for manufacturing containers are disclosed. The system includes one or more manufacturing cells comprised of an unloading station, a queuing/sequencing station, a heating station, an unloading station, and a molding station. The queuing/sequencing station utilizes a plurality of carrier shuttles configured to traverse a platform comprised of a plurality of induction coil sections. Each of the carrier shuttles is provided with a preform mount for receiving a preform thereon. The preforms are selected and the carrier shuttles are arranged in accordance with a predetermined sequence. At least one heater of the heating station is disposed over one of the induction coil sections and adapted to heat the preform. The heated preforms are transported by the carrier shuttles from the heating station to an unloading station, which transitions them to the molding station for a fluid (e.g., gas or liquid) blow molding operation to form the containers.

### CROSS-REFERENCE OF RELATED APPLICATION

This application claims the benefit of U.S. Provisional Patent Application Ser. No. 63/367,380, filed Jun. 30, 2022, the entirety of which is herein incorporated by reference.

### FIELD

This disclosure relates to ways to form and fill containers, and particularly to a method and system that allow for sequencing preforms for manufacturing containers.

### BACKGROUND

Preforms are the products from which containers are made by blow molding. Unless otherwise indicated the term “container” is a broad term and is used in its ordinary sense and includes, without limitation, both the preform and bottle container therefrom. A number of plastic and other materials have been used for containers and many are quite suitable. Some products such as carbonated beverages and foodstuffs need a container, which is resistant to the transfer of gases such as carbon dioxide and oxygen. As a result of environmental and other concerns, various plastic containers, including polyolefin and polyester containers, are used to package numerous commodities previously supplied in glass and other types of containers. Manufacturers and fillers, as well as consumers, have recognized that plastic containers are lightweight, inexpensive, recyclable, and manufacturable in large quantities. Blow-molded plastic containers have accordingly become commonplace in packaging numerous commodities. Examples of plastic materials used in forming blow molded containers include various polyolefins and polyesters, such as polypropylene (PP), polyethylene (PE), high density polyethylene (HDPE), and polyethylene terephthalate (PET).

Traditionally blow molding and filling have developed as two independent processes, in many cases operated by different companies. In order to make container filling more cost effective, some fillers have moved blow molding in house, in many cases integrating blow molders directly into their filling lines. The equipment manufacturers have recognized this advantage and are selling “integrated” systems that are designed to ensure that the blow molder and the filler are fully synchronized. Despite the efforts in bringing the two processes closer together, blow molding and filling continue to be two independent, distinct processes. As a result, significant costs may be incurred while performing these two processes separately. Thus, efforts have been undertaken to develop a liquid or hydraulic blow molding system suitable for forming and filling a container in a single operation.

Additionally, during the blow molding operation a preform that is subsequently blow molded using pressurized liquid or air is passed through a linear oven or heater. The preform traverses along a linear path forward into the oven or heater and then out of the oven or heater, and in continuous processes, multiple preforms are sequentially ordered to pass along the same linear path forward. Because preforms may be sourced from different batches, or may have different ages or water content, precise control of the heating of each preform is difficult to control as the first preform in is the first preform out, and thus there may be a temperature gradient between the first preform and a subsequent preform with some preforms being improperly or unevenly heated, resulting in undesirable variation in container formation from preform to preform. In some instances, the temperature gradient may be significant and render the preform not suitable for blow molding, leading to container rejection and, in some cases, rupture. In the event of unsuitable heating and a rupture of such a preform during blow molding, the entire oven system may be delayed or shut down and any preforms within the system would need to be removed and scrapped. In some cases, this could be up to 50 or more preforms that are then wasted and scrapped.

Known heaters of preforms typically utilize about 200,000 Watts to 400,000 Watts of power per hour to heat preforms during a continuous blow molding operation to support formation of 8,000-16,000 containers per hour, or about 25 watts per preform, and are a part of a system that occupies a large footprint of space, for example, such systems may be around 40 feet long by 28 feet wide by 19 feet high. Use of these levels of power and square footage increases a carbon footprint and cost to manufacture and fill containers. Accordingly, it would be desirable to develop a method and system for manufacturing containers that improves efficiency, minimizes an environmental impact, and reduces waste while consuming less power and occupying less space.

### SUMMARY

In concordance and agreement with the present disclosure, a method and system for manufacturing containers that improves efficiency, minimizes an environmental impact, and reduces waste while consuming less power and occupying less space, has been newly designed.

An object of the present disclosure is to ensure preforms are heated in an order needed for molding to eliminate time, resource, and efforts traditionally required by in-line linear heating. The method and system of the present disclosure eliminates the requirement for handling and human decision-making during preform heating. It also eliminates moving unneeded materials and containers around a facility, reducing warehousing space required.

In an embodiment, a heater for a preform, comprises: at least one first heating element positioned in a substantially vertical orientation; and a plurality of second heating elements disposed adjacent the at least one first heating element, wherein the second heating elements are positioned in a substantially horizontal orientation.

In another embodiment, a heater for a preform, comprises: at least one heating element configured to be selectively controlled and selectively positioned based on the preform being heated.

In another embodiment, a heater for a preform, comprises: at least one heating element configured to be selectively controlled and selectively positioned based on a container formed from the preform being heated.

In another embodiment, a manufacturing cell for a container, comprises: a plurality of stations configured to manufacture the container from a preform, wherein one of the stations is a heating station including a plurality of heaters, and wherein each of the heaters is configured to be at least one of selectively controlled and selectively positioned based on the preform being heated therein.

In another embodiment, a manufacturing cell for a container, comprises: a plurality of stations configured to manufacture the container from a preform, wherein one of the stations is a queuing/sequencing station configured to arrange a plurality of the preforms in a predetermined sequence for heating.

In another embodiment, a system for manufacturing a container, comprises: a supply source for preforms used to manufacture the container; at least one manufacturing cell in communication with the supply source and configured to manufacture the container from the preforms, wherein the at least one manufacturing cell comprises: a loading station for providing a plurality of the preforms; a queuing/sequencing station configured to arrange the preforms in a predetermined sequence for heating, and wherein the queuing/sequencing station includes a platform and a plurality of carrier shuttles configured to traverse over the platform; a heating station including a plurality of heaters, and wherein each of the heaters is configured to be at least one of selectively controlled and selectively positioned based on a desired preform being heated therein; an unloading station for moving the heated preforms from the queuing/sequencing station; and a molding station for receiving the heated preforms from the unloading station, wherein the molding station is configured to mold the container from one of the heated preforms; and a destination location for receiving the molded container.

In another embodiment, a method for manufacturing a container, comprises: providing a manufacturing cell including a plurality of stations configured to manufacture the container from a preform, wherein one of the stations is a heating station including a plurality of heaters; and at least one of selectively controlling and selectively positioning at least one of the heater based on a preform being heated therein.

In another embodiment, a method for manufacturing a container, comprises: providing a manufacturing cell including a plurality of stations configured to manufacture the container from a preform, wherein one of the stations is a queuing/sequencing station configured to move a plurality of the preforms between the stations; and arranging the preforms into a predetermined sequence for heating.

In another embodiment, a method system for manufacturing a container, comprises: providing a supply source for preforms used to manufacture the container; providing at least one manufacturing cell in communication with the supply source and configured to manufacture the container from the preforms, wherein the at least one manufacturing cell comprises: a loading station for providing a plurality of the preforms; a queuing/sequencing station configured to move the preforms within the at least one manufacturing cell, and wherein the queuing/sequencing station includes a platform and a plurality of carrier shuttles configured to traverse over the platform; a heating station including a plurality of heaters configured to heat preforms; an unloading station configured to move the heated preforms from the queuing/sequencing station; and a molding station configured to receive the heated preforms from the unloading station and mold the container from one of the heated preforms; and providing a destination location for receiving the molded container; supplying the plurality of preforms to the at least one manufacturing cell; loading desired preforms into the queuing/sequencing station according to a predetermined sequence; arranging the preforms into the predetermined sequence for heating; moving one of the desired preforms according to the predetermined sequence to one of heaters at the heating station using one of the carrier shuttles; at least one of selectively controlling and selectively positioning the heater based on the desired preform being heated therein; heating the desired preform to a desired temperature; moving the heated desired preform according to the predetermined sequence to the molding station; molding the heated preform into the container; and moving the molded container to the destination location.

As aspects of some embodiments, the at least one first heating element is configured to be selectively controlled during a heating of the preform.

As aspects of some embodiments, the at least one first heating element is configured to be selectively controlled based on the preform being heated.

As aspects of some embodiments, each of the second heating elements is configured to be selectively controlled during a heating of the preform.

As aspects of some embodiments, each of the second heating element is configured to be selectively controlled based on the preform being heated.

As aspects of some embodiments, the at least one first heating element is configured to be selectively positioned relative to at least one of the second heating elements and the preform.

As aspects of some embodiments, each of the second heating elements is configured to be selectively positioned relative to at least one of each other, the at least one first heating element, and the preform.

As aspects of some embodiments, the at least one first heating element is configured to be selectively positioned based on the preform being heated.

As aspects of some embodiments, each of the second heating elements is configured to be selectively positioned based on the preform being heated.

As aspects of some embodiments, certain ones of the second heating elements are grouped together to form a plurality of heating zones of the heater.

As aspects of some embodiments, each of the heating zones is configured to be selectively controlled during a heating of the preform.

As aspects of some embodiments, each of the heating zones is configured to be selectively controlled based on the preform being heated.

As aspects of some embodiments, each of the heating zones is configured to be selectively positioned relative at least one of each other, the at least one first heating element, and the preform.

As aspects of some embodiments, each of the heating zones is configured to be selectively positioned based on the preform being heated.

As aspects of some embodiments, the at least one first heating element provides a primary heating of the preform and the second heating elements provides a secondary heating of the preform.

As aspects of some embodiments, the heater is configured to maintain a desired temperature of the preform during a hold mode.

As aspects of some embodiments, at least one of the second heating elements is disposed on one side of the at least one first heating element and at least one of the second heating elements is disposed on an opposite side of the at least one first heating element.

As aspects of some embodiments, the at least one first heating element and the second heating elements are coupled together to form a modular heater.

As aspects of some embodiments, a plurality of modular heaters including the first and second heating elements together consume less than 28,000 Watts of power per hour to support a two-second container forming cycle time equivalent to 1800 containers per hour, or about 15.6 watts per preform.

As aspects of some embodiments, the queuing/sequencing station includes a platform and a plurality of carrier shuttles configured to traverse over the platform.

As aspects of some embodiments, the platform includes a plurality of induction coil sections.

As aspects of some embodiments, at least one of the carrier shuttles is configured to rotate at a speed in a range of about 0 rpm to about 35 rpm.

As aspects of some embodiments, at least one of the carrier shuttles is configured to be selectively positioned along and relative to an x-axis, a y-axis, and a z-axis.

As aspects of some embodiments, at least one of the carrier shuttles includes at least one magnet.

As aspects of some embodiments, magnetic levitation causes at least one of the carrier shuttles to be elevated above the platform.

As aspects of some embodiments, at least one of the carrier shuttles is provided with a preform mount including an element complementing internal geometry of the preform.

As aspects of some embodiments, the element of the preform mount includes a heating device configured to provide internal heating to the preform.

As aspects of some embodiments, at least a portion of the preform mount is formed from a conductive material.

As aspects of some embodiments, the preform mount of at least one of the carrier shuttles is interchangeable.

As aspects of some embodiments, at least one of a cross-sectional shape, an outer diameter, and an outer profile of the preform mount of at least one of the carrier shuttle is generally constant along a central axis thereof.

As aspects of some embodiments, at least one of a cross-sectional shape, an outer diameter, and an outer profile of the preform mount of at least one of the carrier shuttle varies along a central axis thereof.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings.

FIG. 1 is a bottom perspective view of a preform used in a manufacturing of the container;

FIG. 2 is a schematic representation of a manufacturing cell of a modular system comprising a platform surrounded by various manufacturing stations and one or more carrier shuttles configured to traverse the platform to transport preforms to and from the various manufacturing stations;

FIG. 3 is a schematic representation of a plurality of induction coil sections which comprise the platform and a plurality of carrier shuttles having preforms disposed thereon;

FIG. 4 is a top perspective view of one of the carrier shuttles shown in FIGS. 2 and 3;

FIG. 5 is a side perspective view of a heater used in one of the various manufacturing stations of the modular system of FIG. 2; and

FIG. 6 is a side perspective view of an inspection device used in the manufacturing cell of FIG. 2.

### DETAILED DESCRIPTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

Regarding methods disclosed, the order of the steps presented is exemplary in nature, and thus, the order of the steps can be different in various embodiments. “A” and “an” as used herein indicate “at least one” of the items is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combinations of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

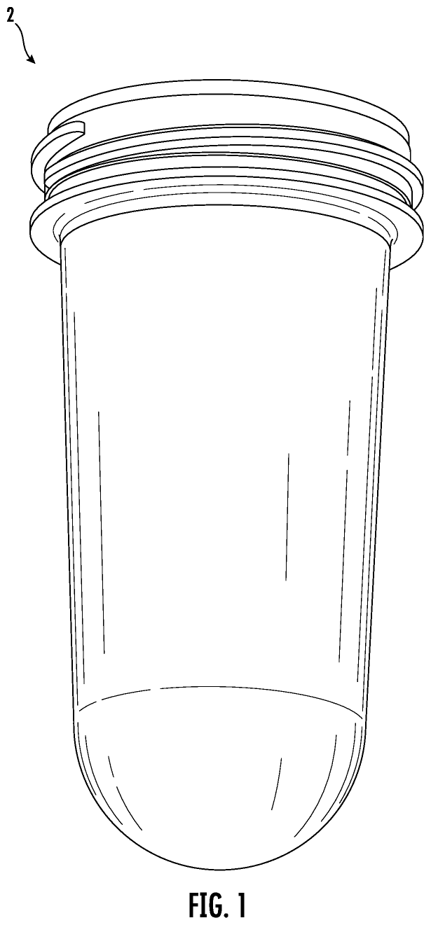

In accordance with, and as shown by, the accompanying figures, a just-in-time (JIT) modular system and method for manufacturing containers is provided. It is understood that the system and method may be operated to blow mold containers using pressurized fluids, including gases or liquids, to form raw materials or work-in-process (WIP) materials (e.g., a preform 2 depicted in FIG. 1) into containers, and is not restricted by the particular fluid used. The system, method, and the preforms 2 flowing through the system may be monitored and/or controlled automatically such as by an adaptive manufacturing software application (AMSA), for example. This may comprise software being executed on one or more computing devices which may be onsite, remote, and/or virtual or cloud-based. Each computing device may include one or more controllers (e.g., a proportional-integral-derivative (PID), programmable logic controller (PLC), and the like, etc.) and/or have one or more processors, memory, storage for storing the data and storing/executing the programs and software particular to the operation of the system. Human machine interfaces (HMIs) such as tablets or other control consoles (e.g., with touch screen displays for providing information to users/operators and receiving input from the users/operators may be in communication with the computing device or integrated the system. Control and communication by/with the computing device may be direct or indirect via analog or digital hardwiring (e.g., Ethernet) or wireless (e.g., WiFi or Bluetooth) or combinations thereof.

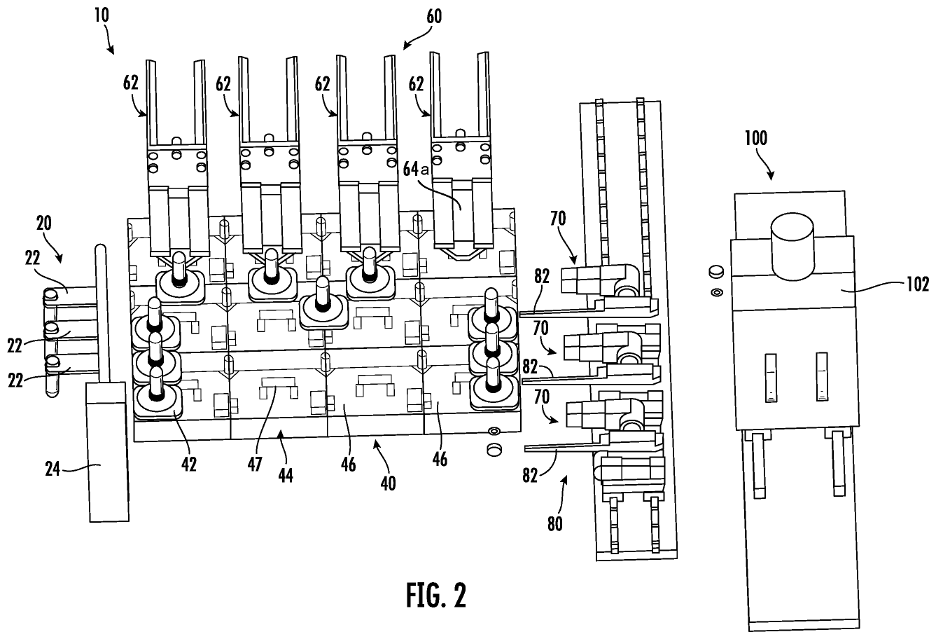

FIG. 2 depicts a manufacturing cell 10 of the modular system according to an embodiment of the present disclosure. Depending on the system there may be one or more of the cells 10. Multiple cells 10 may be arranged in a linear and/or stacked configuration to minimize a footprint of the system. Each cell 10 may also be relatively low weight making it suitable for systems and facilities that have weight restrictions. In such configurations, within each cell 10, there may be multiple machines or stations performing separate tasks involved. In one embodiment, the manufacturing steps are performed by associated stations 20, 40, 60, 80, 100. Depending on the cells 10 these may include a loading step at station 20 (“loading station”), queuing and sequencing steps at station 40 (“queueing/sequencing station”), a heating step at station 60 (“heating station”), an unloading step at station 80 (“unloading station”), and/or a molding step at station 100 (“molding station”) and may have varied degrees of automation. In some embodiments, the multi-station cell 10 may utilized one or more controllers, which may integrate with all or multiple stations 20, 40, 60, 80, 100 in the cell 10, and may be in communication with each other and/or the computing device discussed hereinabove. In the illustrated example, the steps are sequential (e.g., flow is from the loading station 20, to the queuing/sequencing station 40, to the heating station 60, to the unloading station 80, and to molding station 100). Each of the stations 20, 40, 60, 80, 100 is described in detail hereinafter. More or less complex cells 10 may be designed.

A non-limiting example is the cell 10 operating in a just-in-sequence (JIS) mode. In this situation, the containers are manufactured according to a predetermined and optimized production schedule. The production schedule has various containers corresponding to specific customer orders and/or manufacturing demand. These containers may all be manufactured in sequence by the cell 10, and are not required to be produced by conventional batch manufacturing.

In the illustrated embodiment, the loading station 20 is configured to load the preforms 2 onto carrier shuttles 42 utilized by the queuing/sequencing station 40. In some instances, the loading station 20 comprises one or more positioning mechanisms 22 (e.g., grippers) and at least one actuator 24 (e.g., a rotary servomotor) for causing movement of the positioning mechanisms 22. Each of the positioning mechanisms 22 may be configured to selectively obtain a predetermined one of the preforms 2 from a supply source (not depicted) and dispose such preform 2 onto an associated one of the carrier shuttles 42. The positioning mechanisms 22 shown in FIG. 2 are configured to obtain the preforms 2 with threads thereof in an upper position and then while moving them to the carrier shuttles 42, rotate them 180 degrees, so that the threads are in a lower position when the preforms 2 are disposed on the carrier shuttles 42. It is understood that the loading station 20 of the cell 10 may employ any suitable means and methods of receiving the preforms 2 from the supply source, transporting, and disposing the preforms 2 on the carriers shuttles 42 as desired.

Once loaded, the preforms 2 travel on the carrier shuttles 42 to the queuing/sequencing station 40 to be positioned and arranged into a predetermined sequence according to the production schedule for JIT manufacturing of the containers. In some embodiments, each of the carrier shuttles 42 may be assigned a unique identifier and/or readable indicia for tracking, control, and/or data collection by the computing device. Accordingly, the computing device of the system is able to automatically monitor and/or control the movement of the carrier shuttles 42, and thereby monitor and control the movement of the specific preforms 2 to and from the various stations 20, 40, 60, 80 of the cell 10 during JIS/JIT operations. As such, the manufacturing of the containers may commence without time-consuming homing procedures or manual input by the user/operator. The computing device may also be configured to reposition and re-sequence the preforms 2 using the carrier shuttles 42 in the event of delay, defective parts, maintenance, and/or repair within the cell 10 or elsewhere in the system. For example, heated preforms 2 from the heating station 60 may be maintained within the queuing/sequencing station 40 in the event of a backlog at the molding station 100.

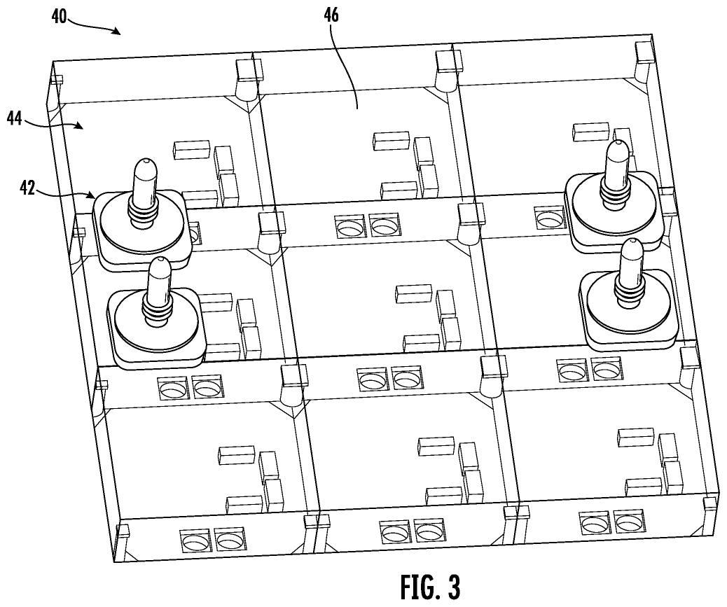

As best seen in FIG. 3, the queuing/sequencing station 40 may utilize a platform 44 comprising one or more sections 46 and the carrier shuttles 42. In a non-limiting example, the platform 44 has nine sections 46 that are generally square shaped, each having a length of about 240 millimeters and a width of about 240 millimeters. It is understood, however, that any number of sections 26 may be employed in the platform 44, and each of the sections 46 may have any suitable size, shape, and configuration as desired.

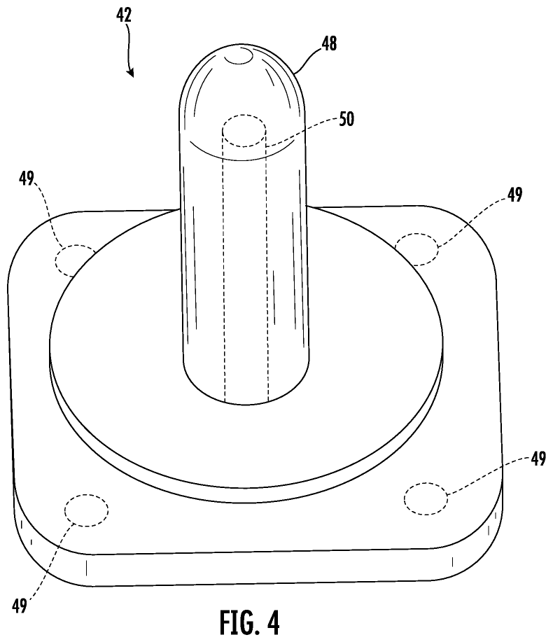

Each section 46 may include an electromagnetic induction coil 47. Each of carrier shuttles 42 traverses the platform 44 of the queuing/sequencing station 40 to transport the preforms 2 to and from the various stations 20, 60, 80 adjacent the platform 44. As more clearly shown in FIG. 4, each of the carrier shuttles 42 may be provided with a preform mount 48. The preform mount 48 may be configured to be at least partially received into a hollow cavity formed in the preform 2 to support and maintain the preform 2 thereon. In the embodiment depicted, the preform mount 48 has a generally circular cross-sectional shape. It is understood, however, that the preform mount 48 may have any suitable geometry complementing cross-sectional shape such as an elliptical, square, rectangular, triangular, and the like, or an irregular cross-sectional shape, for example. It is also understood that the cross-sectional shape of the preform mount 48 may remain constant or vary along a central axis thereof. For instance, a lower portion of the preform mount 48 may have a generally circular cross-sectional shape and an upper portion of the preform mount 48 may be a generally elliptical cross-sectional shape. It is further understood that an outer diameter/profile of the preform mount 48 may be generally constant or vary along the central axis thereof. In some cases, the cross-sectional shape and/or the outer diameter/profile of the preform mount 48 may depend on the preform 2 to be heated and/or a size, shape, and configuration of the container to be molded from the preform 2. For example, a preform for manufacturing a container having a triangular shaped body may be best transported by a carrier shuttle 42 having a preform mount 48 with triangular shaped cross-section. In certain embodiments, the preform mount 48 for each carrier shuttle 42 may also be interchangeable. Hence, the preform mount 48 with certain properties and characteristics (e.g., cross-sectional shapes, constant or varying outer diameter/profile) may be easily swapped out for another preform mount 48 with different properties and characteristics needed for the preform 2 to be heated according to the predetermined sequence.

In certain embodiments, the carrier shuttles 42 may be magnetic levitation (maglev) shuttles 42 configured to cooperate with the electromagnetic induction coil sections 46. Magnetic levitation causes the carrier shuttles 42 to be elevated above the platform 44 with no support other than by a magnetic force used to counteract a gravitational force. In respect of the maglev carrier shuttles 42, each includes one or more integrated magnets 49 such that the carrier shuttle 42 is configured to “float” over a surface of the electromagnetic induction coil sections 46. The magnets 49 shown in FIG. 4 are only for illustration purposes and may be located elsewhere within the carrier shuttle 42 as desired. The sections 46 and the carrier shuttles 42 cooperate to cause the preform 2 to move at a speed in a range of about 0 to about 2 meters per second (m/s) and a positioning repeatability of about +/−5 micrometers (μm). Each of the carrier shuttles 42 may be configured to move freely across the platform 44 in two-dimensional space, rotate and tilt along three axes (e.g., x-axis, y-axis, and z-axis), and offer precise control over an exact height of levitation of the preform mount 48 above each induction coil section 46.

It should be appreciated that various other types of carrier shuttles may be employed as the carrier shuttle 42 within the cell 10 of the system.

Responsive to the JIT/JIS operations of the cell and/or the system, the computing device causes a desired preform 2 to move from the queueing/sequencing station 40 into the heating station 60 by controlling the associated carrier shuttle 42. The heating station 60 may comprise one or more heaters 62 arranged in a configuration to allow the heaters 62 to operate separately and be controlled independently from one another. In some embodiments, the heaters 62 may be located adjacent to one another as desired or aligned in a pre-defined configuration. The preform 2 may be received into an associated one of the heaters 62, as opposed to conventional linear heating systems.

Accordingly, the heating station 60 may receive and selectively heat different preforms 2 substantially simultaneously. It should be appreciated that the different preforms 2 may have various predefined or measured characteristics such as different sizes, shapes (e.g., symmetrical, asymmetrical, etc.), configurations, colors, grammages, wall thicknesses, initial temperatures, final temperatures, preferentially heated locations on the preforms, inscribed part numbers, threads for different closure types, and be made from a variety of materials (e.g., PET or HDPE) and resins, and combinations thereof.

The heaters 62 may also have a modular design to be easily repaired and/or removed and replaced without affecting the other heaters 62 in the heating station 60, which in turn minimizes downtime and maintains productivity and efficiency of the system. In some instances, the modular heater 62 may only be offline for a relatively short period of time for repair and/or replacement, as such, an adjustment (i.e., an increase or decrease) of a cycle time of the other heaters 62 and/or a decrease of throughput at the molding station 100 allows continued container manufacturing and prevents ceasing operation of the entire system. The system, and more particularly, the computing device may be configured to monitor the heaters 62 of the heating station 60 to anticipate when the heaters 62 may need repair and maintenance or simply removed and replaced.

Each of the heaters 62 may be located adjacent to one of the sections 46 of the platform 44 and may be include of any number of heating elements 64 (e.g., emitters, lamps, bulbs, etc.). The heating elements 64, especially in the modular heaters 62, may be easily repaired and/or replaced resulting in a relatively short period of downtime of the heater 62 requiring maintenance. The heaters 62 may be configured to increase from a minimum temperature (e.g. about 0 degrees) to a maximum temperature in milliseconds. In some instances, the heaters 62 are not completely shutoff, but remain at a minimal level (e.g. about 5%) and require only milliseconds to reach a maximum level (e.g. about 100%).

Individual heating elements 64 and/or grouped heating elements 64 (“heating zones”) of the heaters 62 may be selectively and independently controlled and/or selectively and independently positioned relative to the preform 2 to accommodate different preforms 2 (i.e., various sizes, shapes, colors, configurations, materials and resins, grammages, wall thickness, initial temperature, final temperature, preferentially heated locations on the preform, inscribed part number, threads or combinations thereof), adapt for diminishing life of the heating elements 64, and adjust for changes in the preforms 2 during heating. To be selectively and independently controlled, an activation and intensity level of each of the individual heating elements 64 and/or the heating zones may be adjusted, for example, either upward to increase the activation and the intensity level to generate more heat or downward to cease the activation or decrease the intensity level to cease or generate less heat. Similarly, to be selectively and independently positioned, each of the individual heating elements 64 and/or the heating zones may be moved in three-dimensional space, rotated and tilted along three axes (e.g., x-axis, y-axis, and z-axis), and offer precise control over an exact spacing between the heating element 64 and/or the heating zones and the preform 2 being heated. For example, the heating elements 64 and/or the heating zones may be moved towards in closer proximity to the preform 2 to minimize the spacing therebetween and increase a transfer of heat from the heating elements 64 and/or the heating zones to the preform 2 or moved away to distance themselves and maximize the spacing therebetween, which decreases the transfer of heat from the heating elements 64 and/or the heating zones to the preform 2. Activation and intensity level control and positioning of the heating elements 64 and/or heating zones of the heaters 62 may be automated by the computing device, manual, or combinations thereof. In a non-limiting example, the heating elements 64 and/or heating zones may be selectively and independently controlled to provide relatively high heat to an upper portion of the preform 2 and relatively low heat to a lower portion of the preform 2. In another non-limiting example, the heating elements 64 and/or heating zones with diminished life may be positioned closer to the preform 2 during heating, whereas new heating elements 64 and/or heating zones may be positioned farther away from the preform 2. In yet another non-limiting example, the heating elements 64 and/or heating zones on one side of the preform 2 may be positioned closer than the heating elements 64 and/or heating zones on an opposite side of the preform 2 to accommodate the various preforms 2 such as an asymmetrical preform 2.

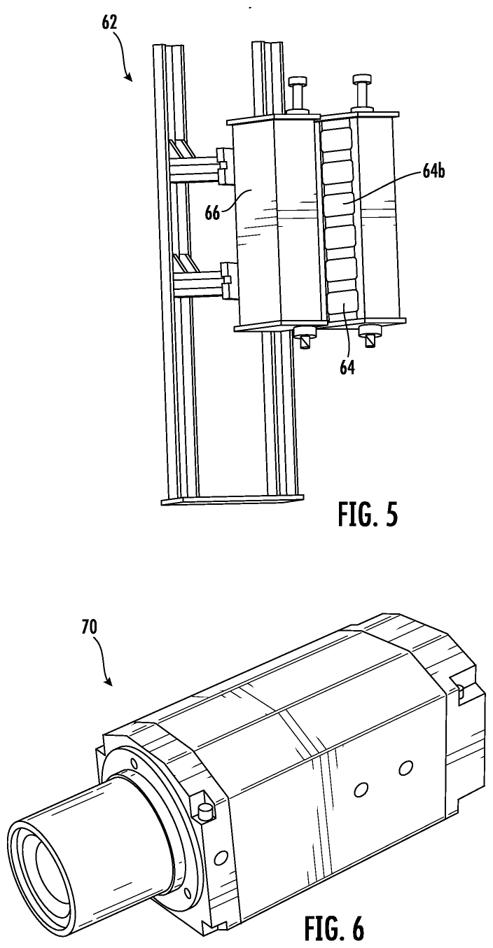

In some embodiments, each of the heaters 62 includes a shroud 66 with a plurality of emitters inside and a plurality of heat lamps located on each side of the heater 62 between which the preform 2 may be disposed. The shroud 66 and the heating element 64 may be coupled together to form the modular heater 62. Each of the heating elements 64 may be disposed in the heater 62 in a vertical orientation, a horizontal orientation, or any orientation therebetween. In one preferred embodiment, the heater 62 includes a substantially vertical heating element 64a (e.g., a single vertical light bulb depicted in FIG. 2) disposed between opposing banks of substantially horizontal heating elements 64b depicted in FIG. 5). The one or more vertical heating elements 64 may provide the primary heating of the preforms 2 and the horizontal heating elements 64 may provide the secondary heating. As a non-limiting example, the vertical heating element 64 provides 80% of the heating of the preform 2 by first heating for 0-1.5 seconds before the banks of the horizontal heating elements 64 are activated. Yet, in other embodiments, the preferential heating is accomplished by the horizontal heating elements 64.

In the illustrated example depicted in FIG. 5, the heater 62 includes a stainless steel shroud 66 with twelve (12) 450 Watt (W) emitters inside and six (6) horizontal heat lamps on each side of the heater 62. The presence or absence of the shroud 66, the number of the heating elements 64, the arrangement of the heating elements 64, heat emission therefrom, and/or power compsumption thereof, may be greater or lesser depending on a throughput of the system, the container to be manufactured, a container forming cycle time, the preform 2 to be heated, and/or a speed of heating of the preform 2 desired.

In certain embodiments, the heater 62 may be configured to output about 2,000 Watts of power while consuming less than 28,000 Watts of power per hour to support a two-second container forming cycle time equivalent to 1800 containers per hour, or about 15.6 watts per preform, which is a substantial power decrease from conventional blow molding ovens and heating systems that consume about 450,000 Watts of power. The heaters 62 may be configured to only consume the power needed to selectively heat the specific preforms 2, wherein the conventional blow molding ovens and heating systems require specific preheat treatment, are not adjustable, and constantly operate at fully intensity.

In some embodiments, the heater 62 may also be supplemented by use of a laser (not depicted) in communication with an access opening 68 of the heater 62 and any preform 2 disposed therein. The laser may be used to directly heat the preform 2 at a specific location.

In other embodiments, the heater 62 may also be supplemented by a heating device 50 disposed on or integrally formed with the preform mount 48 of the carrier shuttles 42 to internally heat the preforms 2. The preform mount 48 may include an element that complements the internal geometry of the preform 2, wherein the element includes the heating device 50 configured to provide internal heating to the preform. The preform mount 48 may be selectively preheated by the heating device prior to receiving the preform 2 thereon and transfer such heat to the preform 2. In another embodiment, the preform mount 48 may be preheated by the heaters 62 of the heating station 60 prior to receiving the preform 2 thereon and selectively reheated by induction from the heaters 62 during heating of the preforms 2. The preform mount 48 may be configured to retain heat from the heating station 60 and transfer such heat to the preform 2. For both embodiments, the preform mount 48 may be formed from any conductive material or combinations thereof such as a copper material or a copper alloy material, for example. As discussed hereinabove, the preform mount 48 may also have any suitable cross-sectional shape and/or outer diameter/profile. In some embodiments, the cross-sectional shape and/or the outer diameter/profile of the preform mount 48 may depend on the various preform 2 being heated in order to optimize internal heating and/or provide preferential heating in specific areas of the preform 2 by having the preform mount 48, or certain portions thereof, in close proximity to an inner surface of the preform 2. As a non-limiting example, a lower portion of the preform mount 48 may have a generally triangular shaped cross-section with one outer diameter while the upper portion thereof may have a generally circular shaped cross-section with another outer diameter in order to provide preferential internal heating to a preform for a container having a triangular shaped region adjacent a neck thereof.

The internal heating devices and/or conductive preform mounts 48, the lasers, and/or controlled powering and use of individual heating elements 64 in the heater 62 are improvements over the conventional heating systems and preferential for selectively heating the various preforms 2.

In the illustrated embodiment, the carrier shuttle 42 with the desired preform 2 disposed thereon is caused to move from one of the sections 46 of the platform 44 to another one of the sections 46 that is located beneath a desired one of the heaters 62 of the heating station 60. In this position, the preform 2 may disposed within or adjacent to one of the heaters 62 for heating.

As the preform 2 is moved to the heating station 60, the preform 2 rotates about its central axis at a desired rate. Preferably, the preform 2 may be caused to rotate at a rotational speed in a range of about 0 to about 1000 revolutions per minute (rpm). The rotational speed of the preform may be adjusted to ensure proper and desired heating of the preform 2 within the system. Rotational speed is inversely related to temperature of the preform 2 (e.g., lower rotational speed equates to a higher temperature of the preform 2 and higher rotational speed equates to a lower temperature of the preform 2). Hence, selective rotational speed may be utilized to selectively heat sides or surfaces of the preform 2 differently. The preform 2 may be caused to spin about its central axis while being heated by the heater 62 until the temperature of the preform 2 exceeds its glass transition temperature T_{g}, but before the preform 2 reaches its crystallization temperature T_{c}.

An inspection device 70 may be utilized in the system for automatically detecting the preforms 2. The inspection device 70 may be configured to detect the preforms introduced into the heating station 60, as well as any preforms 2 that have been unintentionally or erroneously introduced into the heaters 62. The inspection device 70 may detect the preform 2 by the unique identifier and/or readable indicia on the associated carrier shuttle 42, or by detecting at least one physical, chemical, and/or geometric property of the preform 2. The inspection device disposed within the system may be at an angle or position to be able to detect the temperature of the preform 2 in the queuing/sequencing station 40 and/or during heating in the heating station 60. Various inspection devices 70 may be employed. In the illustrated embodiment, the inspection device 70 may be a thermo imaging camera (depicted in FIG. 6) in communication with the controller. The inspection device 70 may be wired or wirelessly connected to the controller of the computing device to ensure that the preform 2 is heated to a desired temperature between T_{g} and T_{c}. The inspection device 70 may be configured to monitor the temperature of each preform 2 and facilitate, in cooperation with the computing device, an adjustment of the heating elements 64 of the heater 62 and/or rotational speed of the carrier shuttle 42 to maximize the throughput of the heating. The inspection device 70 may be used by the computing system to anticipate when the heaters 62 may need repair and maintenance or simply removed and replaced by monitoring the heating and time required, and/or temperature of each preform 2.

Once the desired temperature of the preform 2 is reached and in accordance with the predetermined sequence, the preform 2 is removed from the associated heater 62 by the computing device causing the carrier shuttle 42 to traverse from the section 46 underneath the heater 62 of the heating station 60 across the other sections 46 of the platform 44 to the unloading station 80. As such, the predetermined sequence is not necessarily first in, first out of the heating station 60. In some circumstances and for various reasons, the preform 2 that is heated to the desired temperature may not be allowed to be removed from the heater 62 and prevented from being transported from the heating station 60 to the unloading station 80. When such event occurs, the heater 62 may be configured to operate in a “hold” mode to maintain the desired temperature of the preform 2 until it can be removed from the heater 62 and transported to the unloading station 80. The hold mode of the heater 62 may be accomplished by delaying application of heat to the preform, by independently and selectively controlling and/or positioning the heating elements 64 of the heater 62, by selectively heating the preform 2 using the heating device 50 of the preform mount 48, and/or by adjusting the rotational speed of the carrier shuttle 42 having the preform 2 disposed thereon. It is understood that other means and methods may be employed by the cell 10 to maintain the desired temperature of the heated preform 2 prior to transport to the unloading station 80 and subsequently the molding station 100 for forming into a container.

As depicted, the unloading station 80 is configured to unload the preforms 2 from the carrier shuttles 42 utilized by the queuing/sequencing station 40. In some instances, the unloading station 80 comprises one or more positioning mechanisms 82 (e.g., grippers) and at least one actuator 84 (e.g., a 3-axis servomotor) for causing movement of the positioning mechanisms 82. Each of the positioning mechanisms 82 may be configured to obtain the predetermined one of the preforms 2 from the associated carrier shuttle 42 and dispose such preform 2 into an associated mold 102 at the molding station 100. The positioning mechanisms 82 shown in FIG. 2 are configured to obtain the preforms 2 from the carrier shuttles 42 with threads thereof in the lower position and then while moving them to the molding station 100, rotate them 180 degrees, so that the threads are in the upper position when the preforms 2 are disposed in the molds 100. It is understood that the unloading station 80 of the cell 10 may employ any suitable means and methods of receiving the preforms 2 from the carrier shuttles 42, transporting, and disposing the preforms 2 in the molds 102 as desired. Within the mold 102 of the molding station 100, pressurized fluid (e.g., air or liquid) may be introduced into the heated preform 2, and the heated preform 2 is caused to expand and take the shape of the mold 102, and become the container.

For example, from DE 26 57 670 A1 a blow molding and filling head for devices for molding and filling hollow bodies formed from thermoplastic materials is known, in which the molded containers are immediately charged with fill product by means of the blow molding and filling head.

From EP 1 529 620 A1, a filling head is known, in which the inflation of each plastic container is carried out by means of the fill product. Accordingly, the container is fully filled with the fill product immediately when manufacture is completed, so that in this case manufacture and filling take place simultaneously.

In the known methods by which the container is filled while still in the mold 100, the filling takes place in conditions of either ambient pressure or overpressure.

It is understood that the cell 10 of the system described herein may have any desired number of carrier shuttles 42, induction coil sections 46, heaters 62, inspection devices 70, and/or molds 102, as desired. In systems containing multiple heating and/or molding stations 60, 100, the number of platforms 44 desired may vary, and such systems' components will be modular and are able to be expanded and components replaced without removing the system from production. An additional benefit of the system described and shown herein is that the footprint occupied by the cell 10 is substantially smaller than that of known systems and may be about 10 feet by 10 feet by 5 feet depending on the number of heaters 62, molds 102, and other system components. Additionally, such low footprint cells 10 and systems could be stacked on top of one another and adjoining or adjacent to another cell 10 and/or system, as desired.

In cells 10 that utilized multiple heaters 62 in the heating station 60 and/or multiple molds 102 in the molding station 100, the computing device can monitor the heating of multiple preforms 2 simultaneously or at substantially the same time and cause preforms 2 that are heated to the desired temperature to be removed from the heater 62 of the heating station 60 and transferred to the molds 102 of the molding station 100 for blow molding when such preforms 2 are suitable for such operations.

In this way and unlike linear heating systems known in the art, each preform 2 is monitored and heated to an appropriate temperature for suitable blow molding to minimize improper blow molding or filling operations due to improperly heated preforms 2. Each preform 2 within the cell 10 of the system is able to be monitored, heated properly, and removed for blow molding while additional preforms 2 are being prepared to enter the cell 10 because each carrier shuttle 42 is able to move in any direction (forward, back, left, right) across the multiple sections 46 of the platform 44 to facilitate transition through the cell 10. This ensures preforms 2 are heated in a predetermined sequence needed for molding to eliminate time, resource, and efforts traditionally required by the linear heating systems. The method and system of the present disclosure eliminates the requirement for handling and human decision-making during heating of the preforms 2. It also eliminates moving unneeded materials and containers around a facility, reducing warehousing space required.

Minimizing improper heating, molding, and filling operations improves efficiency and minimizes waste from unacceptable containers and preforms 2 that must be recycled or otherwise discarded, minimizes cleaning operations of the cell and the system caused by spills or overflow situations, and minimizes down time of the cell and the system caused by having to conduct repairs and maintenance, while consuming less power and occupying less space.

The system may also include various stores for incoming raw materials, WIP materials, and finished products. Various transportation means (e.g., automated, semi-automated, manual, and combination thereof) for transporting such raw materials, WIP materials, and finished products along a flow path to the loading station 20 and from the molding station 100.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A heater for a preform, comprising:
at least one first heating element positioned in a substantially vertical orientation; and
a plurality of second heating elements disposed adjacent the at least one first heating element, wherein the second heating element are positioned in a substantially horizontal orientation.

2. The heater of claim 1, wherein the at least one first heating element is configured to be selectively controlled during a heating of the preform.

3. The heater of claim 1, wherein the at least one first heating element is configured to be selectively controlled based on the preform being heated.

4. The heater of claim 1, wherein each of the second heating elements is configured to be selectively controlled during a heating of the preform.

5. The heater of claim 1, wherein each of the second heating element is configured to be selectively controlled based on the preform being heated.

6. The heater of claim 1, wherein the at least one first heating element is configured to be selectively positioned relative to at least one of the second heating elements and the preform.

7. The heater of claim 1, wherein each of the second heating elements is configured to be selectively positioned relative to at least one of each other, the at least one first heating element, and the preform.

8. The heater of claim 1, wherein the at least one first heating element is configured to be selectively positioned based on the preform being heated.

9. The heater of claim 1, wherein each of the second heating elements is configured to be selectively positioned based on the preform being heated.

10. The heater of claim 1, wherein certain ones of the second heating elements are grouped together to form a plurality of heating zones of the heater.

11. The heater of claim 10, wherein each of the heating zones is configured to be selectively controlled during a heating of the preform.

12. The heater of claim 10, wherein each of the heating zones is configured to be selectively controlled based on the preform being heated.

13. The heater of claim 10, wherein each of the heating zones is configured to be selectively positioned relative at least one of each other, the at least one first heating element, and the preform.

14. The heater of claim 10, wherein each of the heating zones is configured to be selectively positioned based on the preform being heated.

15. The heater of claim 1, wherein the at least one first heating element provides a primary heating of the preform and the second heating elements provides a secondary heating of the preform.

16. The heater of claim 1, wherein the heater is configured to maintain a desired temperature of the preform during a hold mode.

17. The heater of claim 1, wherein at least one of the second heating elements is disposed on one side of the at least one first heating element and at least one of the second heating elements is disposed on an opposite side of the at least one first heating element.

18. The heater of claim 1, wherein the at least one first heating element and the second heating elements are coupled together to form a modular heater.

19. A heater for a preform, comprising:
at least one heating element configured to be selectively controlled and selectively positioned based on the preform being heated.

20. A heater for a preform, comprising:
at least one heating element configured to be selectively controlled and selectively positioned based on a container formed from the preform being heated.
